(19) United States
(12) Patent Application Publication
(10) Pub. No.: US 2001/0053221 A1
(43) Pub. Date: Dec. 20, 2001

(54) Ciphering apparatus and ciphering method

(75) Inventor: Tsuneharu Takeda, Tokyo (JP)

Correspondence Address: FRISHAUF, HOLTZ, GOODMAN &, LANGER & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 09/882,185

(22) Filed: Jun. 14, 2001

(30) Foreign Application Priority Data
Jun. 20, 2000 (JP) 2000-184778

(51) Int. Cl. H04L 9/00; G06F 12/14

(52) U.S. Cl. 380/37; 713/193; 380/277

(57) ABSTRACT

Ciphering apparatus in which plaintext is divided into blocks, and a ciphering attribute for use in ciphering is set to each block. Each block is ciphered in accordance with the ciphering attribute set for each block, the ciphered blocks are collected, and ciphertext is formed. For deciphering, the ciphering attribute for each block is referred to, each block is deciphered, deciphered results are collected, and the original plaintext is obtained.

### BACKGROUND OF THE INVENTION

The present invention relates to a ciphering apparatus and ciphering method.

These days, the use of computers for general and business purposes is very widespread, and conventional manual procedures have increasingly been replaced by computer processes. In such circumstances, when certain data handled by the computer, such as private data concerning an individual, is exchanged via a computer network, and when the data is used as it is, a problem has occurred that secrecy cannot be sufficiently secured. Therefore, it is necessary to cipher the data, and a sufficiently safe ciphering system with a good operation efficiency has been desired for performing ciphering by the computer.

In conventional ciphering techniques, in general, stream data is divided into several regions (block) data, the respective blocks are subjected to a ciphering process, and all the data is ciphered. WE In this case, security levels for the respective ciphered blocks are set to be the same. That is, the same algorithm is used to cipher the respective ciphering blocks.

As described above, conventional ciphering techniques generally include dividing stream data into several regions (blocks), subjecting the respective blocks to the ciphering process, and ciphering all the data. In this case, the security levels for the respective ciphering blocks are set to be the same. Therefore, when a part of the ciphered data is deciphered, there is a risk or chance that all data will be deciphered.

### BRIEF SUMMARY OF THE INVENTION

Accordingly, the present invention is directed to method and apparatus that substantially obviates one or more of the problems due to limitations and disadvantages of the related art.

An object of the present invention is to provide a ciphering apparatus using a ciphering technique in which even if a part of the data is deciphered, the rest of the data is not easily deciphered.

According to the present invention, there is provided a ciphering apparatus comprising a blocking section which divides plaintext into blocks; an attribute setting section which sets a ciphering attribute for use in ciphering each of the blocks; a ciphering section which ciphers each of the blocks in accordance with a ciphering attribute set for the block to obtain a ciphertext; and an output section which outputs the ciphertext and the ciphering attribute used for obtaining the ciphertext.

According to the present invention, there is provided a ciphering comprising: dividing plaintext into blocks; setting a ciphering attribute for use in ciphering each of the blocks; ciphering each of the blocks in accordance with a ciphering attribute set for the block to obtain a ciphertext; and outputting the ciphertext and the ciphering attribute used for obtaining the ciphertext.

According to the present invention, the ciphering attribute of each part of the ciphertext can be changed. Therefore, even if part of the ciphertext can be deciphered, the rest cannot be deciphered, and a more reliable ciphering technique can be provided. Particularly, a user appropriately determines the ciphering attribute, and it is thereby possible to perform ciphering which meets the user's needs.

Additional objects and advantages of the present invention will be set forth in the description which follows, and in part will be obvious from the description, or may be learned by practice of the present invention.

The objects and advantages of the present invention may be realized and obtained by section of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the present invention and, together with the general description given above and the detailed description of the preferred embodiments given below, serve to explain the principles of the present invention in which:

FIGS. 1A and 1B are explanatory views of a concept of a first embodiment according to the present invention;

FIGS. 2A and 2B are explanatory views of the concept of the first embodiment according to the present invention;

FIGS. 3A and 3B are diagrams schematically showing examples of an attribute data storing method;

FIG. 4 is a diagram showing an example of the constituents of an attribute table for storing attribute data;

FIG. 5 is a flowchart showing a ciphering process;

FIG. 6 is a flowchart showing a deciphering process;

FIG. 7 is a flowchart showing a ciphering process in which data is divided into sub-blocks;

FIG. 8 is a flowchart showing another ciphering process in which data is divided into sub-blocks;

FIG. 9 is a flowchart showing a deciphering process in which data is divided into sub-blocks;

FIG. 10 is a flowchart showing another deciphering process in which data is divided into sub-blocks;

FIGS. 11A to 11F are explanatory views of the concept of a second embodiment according to the present invention;

FIG. 12 is a diagram showing an example of the attribute table in the second embodiment;

FIG. 13 is a flowchart showing a ciphering process in the second embodiment;

FIG. 14 is a flowchart showing a deciphering process in the second embodiment;

FIG. 15 is a flowchart showing a ciphering process in which data is divided into sub-blocks;

FIG. 16 is a flowchart showing another ciphering process in which data is divided into sub-blocks;

FIG. 17 is a flowchart showing a further ciphering process in which data is divided into sub-blocks;

FIG. 18 is a flowchart showing a still another ciphering process in which data is divided into sub-blocks;

FIG. 19 is a block diagram of a ciphering apparatus according to the present invention;

FIG. 20 is a block diagram of a deciphering apparatus according to the present invention; and

FIG. 21 is a diagram showing a hardware of an information apparatus required for realizing the process of the embodiment by a program.

### DETAILED DESCRIPTION OF THE INVENTION

An embodiment of a ciphering apparatus according to the present invention will now be described with reference to the accompanying drawings.

First Embodiment

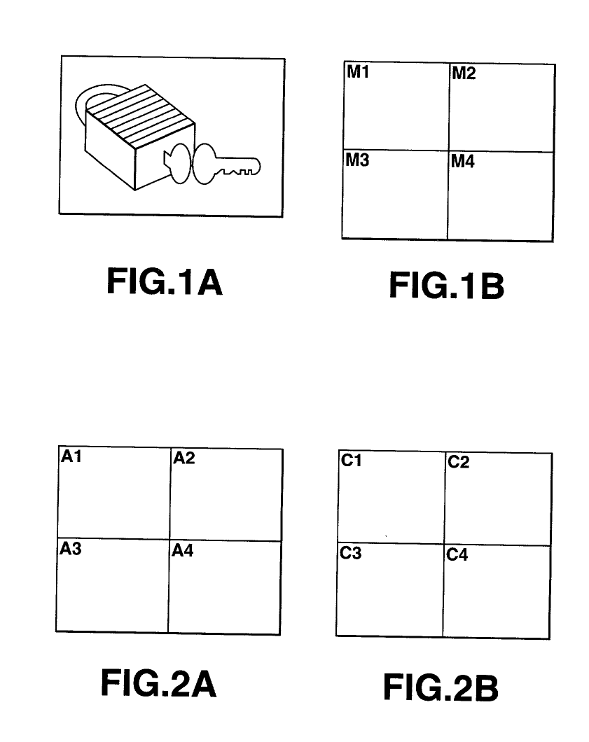

FIGS. 1A, 1B, 2A, and 2B are explanatory views of a concept of the first embodiment according to the present invention.

FIG. 1A schematically shows two-dimensional data of a plaintext M. In the drawing, image data (plaintext) is represented on a two dimensional plane. Moreover, as another example of the two dimensional data, a database content is represented in a table form. In the first embodiment, a ciphering method is shown with respect to data arrangement in which data logically spreads in a plane, or in a solid or another multidimensional manner. Of course, even when the logical structure is one-dimensional, the present embodiment can similarly be applied.

FIG. 1B shows that the plaintext is divided into several blocks. Here, block shapes can be arbitrarily set, and can be set to be the same or to be different from one another. Number “n” attached to M denotes a block number. As described above, in the conventional art, the whole plaintext shown in FIG. 1A is regarded as one block, and this one block of data is divided into regions in such a manner that a predetermined ciphering processing is easily performed. The same key and the same ciphering algorithm are used over all the region data to cipher the data.

On the other hand, in the first embodiment of the present invention, the data having the two dimensional arrangement, for example, of FIG. 1A is divided into a plurality of blocks as shown in FIG. 1B, an inherent ciphering key and an inherent ciphering algorithm are applied to each block, and all the block data is ciphered.

FIG. 2A shows a table of an attribute “An” which defines the ciphering of a plaintext Mn. Here, Mn and An are shown to clarify a one-to-one correspondence. In actuality, however, when the blocks are correctly associated with each other, it is unnecessary to clearly associate the blocks with each other. That is, in FIG. 2A, a ciphering attribute for a plaintext block M1 is A1, and similarly the ciphering attributes for blocks M2 to M4 are A2 to A4. However, for a method of associating the attributes in this manner, it is unnecessary to associate the arrangement positions of two-dimensional data shown in FIG. 2A. Instead, a pointer is attached to each of the divided blocks of the plaintext M, and the pointer may be constituted to indicate a position in which the ciphering attribute is stored.

FIG. 2B shows a ciphertext block “Cn” obtained by ciphering the plaintext block Mn with the ciphering attribute An. That is, in FIG. 2B, ciphertext data obtained by using the ciphering attribute A1 to cipher the plaintext M1 is C1, and similarly ciphertext data C2 to C4 are obtained by using the ciphering attributes A2 to A4 to cipher the plaintexts M2 to M4, respectively.

Here, the ciphering attributes A1 to A4 are, for example, ciphering keys or algorithms for ciphering.

In FIGS. 1A, 1B, 2A, and 2B, the plaintext block Mn and ciphertext block “Cn” are shown as the same shape, but the shape may generally differ.

According to the aforementioned ciphering method, since two dimensional arrangement data {Cn} and ciphering attribute {An} are stored, a deciphering processing may be performed on the stored ciphered two dimensional data {Cn} based on the ciphering attribute {An} in order to obtain the two dimensional plaintext data.

In the first embodiment, when the two dimensional data of the plaintext is divided into several blocks, and the ciphering attributes for the respective blocks are used to cipher the blocks, the ciphering attribute can be finely and effectively set during the ciphering of each block. For example, an attribute “this block is not ciphered” can also be set. There can be provided a practical and convenient property in which the ciphered data can be an object of a full-text search, without damaging the safety of the ciphered data. That is, for example, when a database constituted of two-dimensional data is ciphered, the attribute “this block is not ciphered” is given to a field with an item registered as a keyword of a database search therein. Thereby, other data can be ciphered without ciphering the keyword. Then, the keyword can be used to search the database without decrypting the whole database. An entry (data record including the keyword) obtained as a result of the search can be deciphered and used if necessary. Therefore, it is unnecessary to decipher the whole database. Even if a user does not obtain the right to see a certain data item of the database, the user is allowed to use the database while the data of the item is kept concealed.

This is not limited to the database. For example, when image data is ciphered according to the embodiment of the present invention, a portion desired to be seen only by a specific user, such as company secret, is ciphered using a ciphering key different from that keys of other portions. In this case, other users can be permitted to use the image data while only the portion is kept secret.

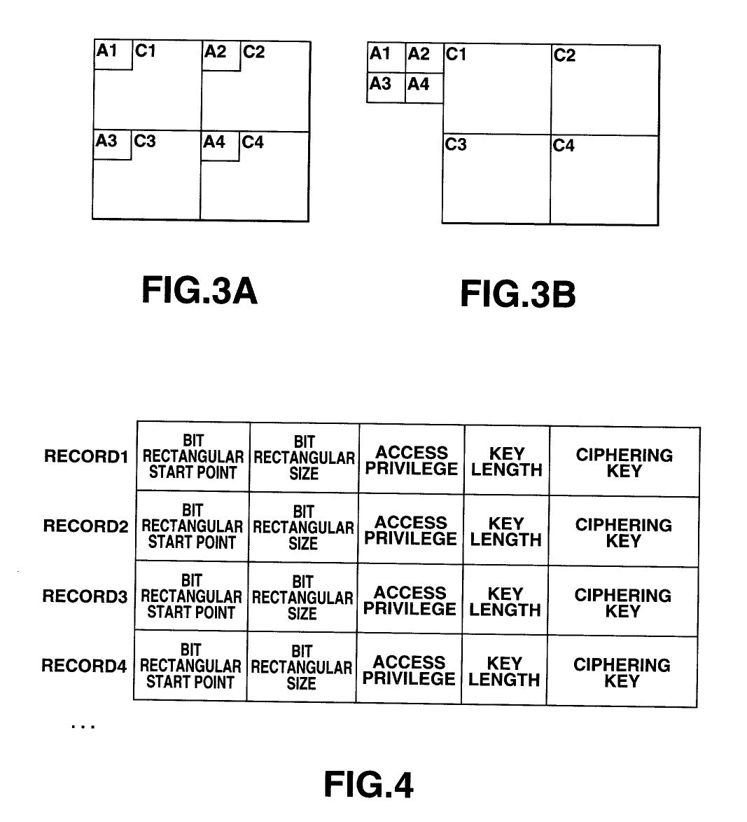

FIGS. 3A and 3B are diagrams schematically showing examples of an attribute data storing method.

In the first embodiment, it is assumed that the two dimensional data {Cn} and attribute data {An} are managed separately. That is, the ciphertext {Cn} and attribute data {An} are recorded as separate files in a recording medium. During deciphering, the attribute data {An} is set for the corresponding ciphertext {Cn} to decipher the data, and the original plaintext M is obtained. Additionally, {An} and {Cn} may be managed together as one unit of data, for example, as shown in FIGS. 3A and 3B. That is, in FIG. 3A and FIG. 3B, the ciphertext {Cn} and attribute {An} are stored as one file in such a manner that the correspondence relation between the data can be recognized. In FIG. 3A, the attribute {An} is stored in a part of a storage region of the ciphertext {Cn}. During deciphering, a data region to be deciphered is obtained, the attribute {An} is first read from the region. Next, the ciphertext {Cn} is read, and a deciphering processing is performed. Alternatively, as shown in FIG. 3B, an attribute data group {An} is added separately from a ciphertext data group {Cn}, and may be stored in the recording medium. During deciphering, first, the attribute data {An} is read, and next the ciphertext data {Cn} corresponding to the read attribute data {An} is read and deciphered. Particularly, in the example of FIG. 3B, an identifier indicating the ciphertext “Cn” corresponding to the attribute An is added to each attribute data {An}.

In the first embodiment, the two-dimensional plaintext data is divided into blocks having arbitrary shapes, and the block is ciphered in accordance with the defined ciphering attribute for each block. As an example of this modification, possible is a method of dividing the two dimensional data of the plaintext into blocks, defining the ciphering attribute for each block, further dividing the block into micro regions (sub-blocks), and setting a new attribute for the ciphering of each sub-block to cipher each sub-block.

In the modification, the block obtained by dividing the two dimensional data of the plaintext in the first embodiment is further divided into the micro sub-blocks, and the new ciphering attribute is set for each sub-block. Therefore, attribute hierarchy is realized, and the hierarchy of security management is effectively realized based on the hierarchical attribute. That is, this modification is applied to ciphering of a personnel management database, and the ciphering key can be set in such a manner that a clerk of the personnel department can search employee names, addresses and telephone numbers, but only management staff of the personnel department can see earned incomes and employee's private information.

In the modification, the plaintext is divided into blocks, the ciphering attribute is set for each block, subsequently each block is further divided into sub-blocks, and a new ciphering attribute is set for the obtained sub-block. However, it is also possible to regard the “block” obtained by the aforementioned first step procedure as the sub-block, collect several blocks to obtain and constitute a huge block (cluster), and impart the new ciphering attribute to each cluster. In this case, the hierarchical structure of the plaintext block is formally the same as that of the modification, but the hierarchical structure of the ciphering attribute is reversed.

In another modification, the “block” is divided into sub-blocks as in the aforementioned modification. Instead of ciphering each sub-block, after the block is ciphered, and the ciphered block is divided into sub-blocks, the sub-block may be ciphered.

FIG. 4 is a diagram showing an example of the constitution of an attribute table for storing ciphering attribute data.

Each record is arranged in each block of the plaintext in the attribute table. Moreover, stored in one record are: a block start point address of the sub-block which is obtained by dividing the plaintext (“bit rectangular start point”, in this case the block is formed to be rectangular); a “bit rectangular size” (a block size of a pixel unit is represented by a bit); an access privilege (a value defining users who are authorized to decipher and access the block); a key length; and a ciphering key. When the attribute table is stored as shown in FIG. 3A, the respective records are attached to the respective ciphered blocks at random. These records may differ with all the plaintext blocks, and the same information may sometimes be stored with respect to a plurality of blocks.

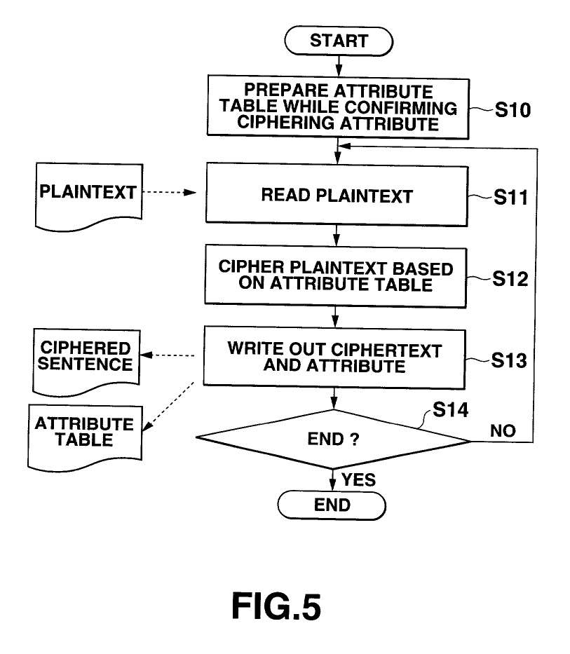

FIG. 5 is a flowchart showing a ciphering process.

In step S10 the attribute table is prepared while the ciphering attribute is confirmed. For input of the attribute, for example, a user who wishes to cipher the plaintext inputs the attribute. In step S11 the plaintext is read. In step S12 the plaintext is ciphered based on the attribute table, and in step S13 the ciphertext and attribute are simultaneously written out. Thereby, the ciphered data and attribute table are prepared. For a method of storing the ciphered data and attribute data, as described above, the ciphered data and attribute data may be stored as separate files, or combined and stored as one file. In step S14, the user is requested to input whether or not the ciphering processing is to be ended. If the processing is not ended, the process returns to step S11, and the process is repeated. If the process is to be ended, the process is ended as it is.

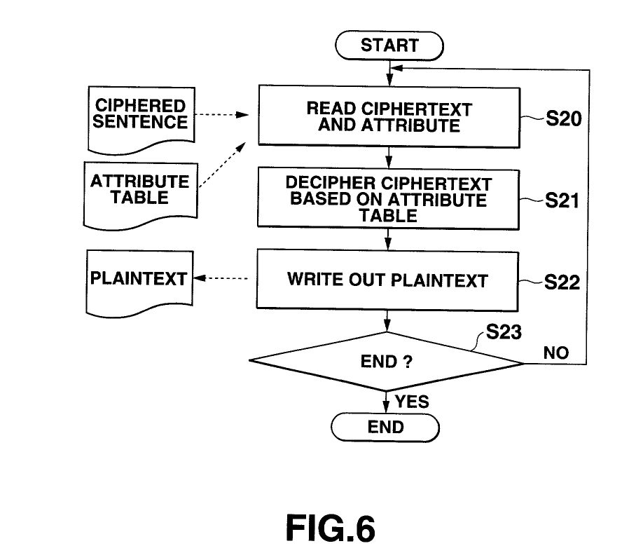

FIG. 6 is a flowchart showing a deciphering process.

In step S20, the ciphertext is read, and the attribute is read from the attribute table. In step S21 the ciphertext is deciphered based on the attribute table, and in step S22 the deciphered plaintext is written out. In step S23 the user is requested to instruct whether or not to end the deciphering process. If the process is not ended, the process advances to the step S20. If the process is to be ended, the process is ended as it is.

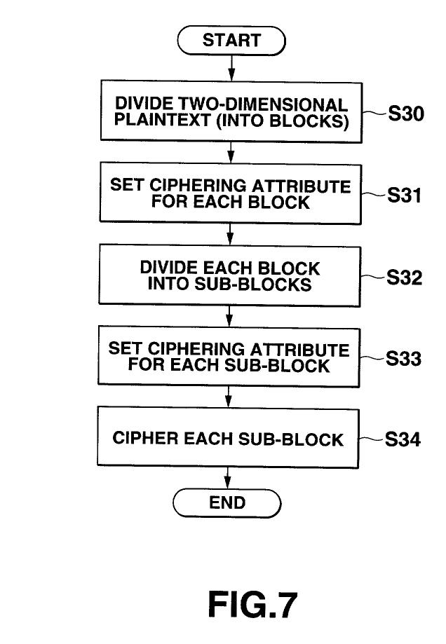

FIG. 7 to FIG. 10 are flowcharts showing ciphering processes in cases in which data is further divided into sub-blocks.

In FIG. 7, in step S30, the two dimensional plaintext is divided and formed into blocks. Subsequently in step S31 the ciphering attribute is set to each block. This setting is performed, for example, by the user. In step S32 each block is further divided into sub-blocks. Then, in step S33 the ciphering attribute is set to each sub-block. This setting is also performed, for example, by the user. In step S34 each sub-block is ciphered based on the ciphering attribute for each sub-block and the process is ended. In this case, the sub-block is ciphered only based on the ciphering attribute for each sub-block. During ciphering of the sub-block, however, it is preferable to reflect not only the attribute set to the sub-block but also the attribute set to the original block. For example, the setting of the access privilege will be described. For a right to access the sub-block, only the user who satisfies not only the access privilege set to the sub-block attribute but also the access privilege set to the original block is permitted to access the sub-block.

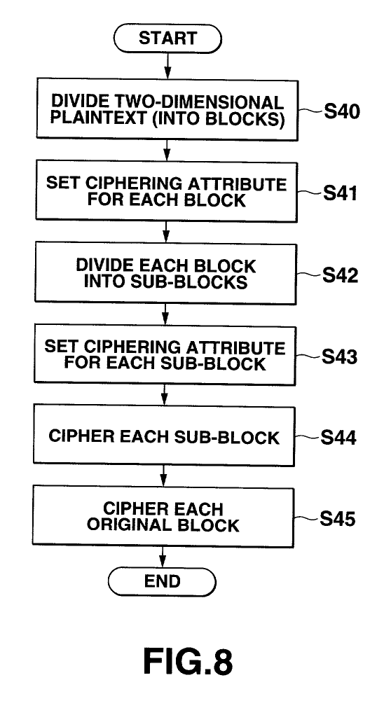

In FIG. 8, both the sub-block and the original block are ciphered. That is, in step S40, the two dimensional plaintext is divided into blocks. In step S41 the ciphering attribute is set to each block, for example, by the user. In step S42 each block is divided, to generate sub-blocks, and in step S43 the ciphering attribute is set to each sub-block, for example, by the user. In step S44 each sub-block is ciphered in accordance with the sub-block ciphering attribute. In step S45 the ciphered sub-blocks are collected to form original block units, and each block is ciphered based on the ciphering attribute.

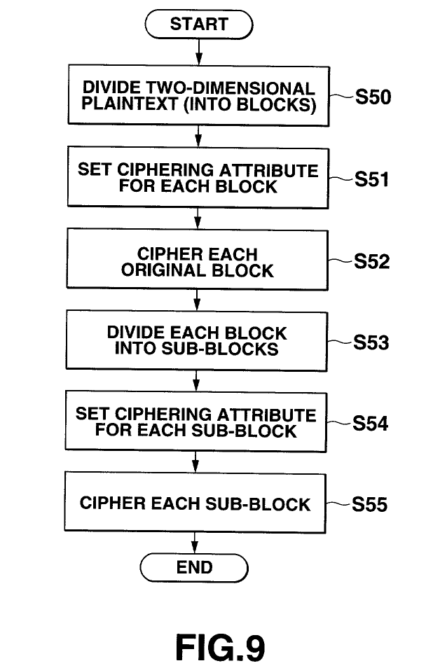

In FIG. 9, after the blocks are formed, each block is ciphered, then divided into sub-blocks, and each sub-block is further ciphered. In step S50 the two-dimensional plaintext is divided and formed into blocks. In step S51 the ciphering attribute is set to each block, for example, by the user. In step S52 each block is ciphered based on the ciphering attribute. In step S53 each ciphered block unit is divided into sub-blocks, and in step S54, for example, the user sets the ciphering attribute to each sub-block. In step S55, each sub-blocks obtained from the ciphered block unit is ciphered, and the process is ended.

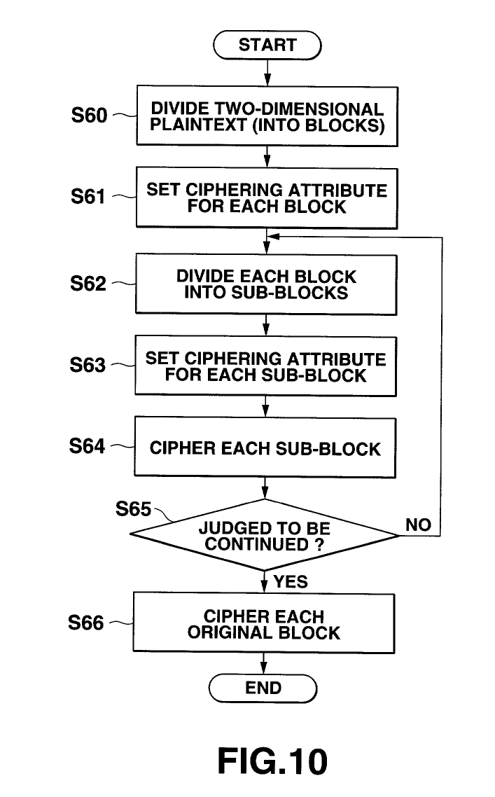

FIG. 10 shows a process for further dividing the sub-block into small blocks, and successively ciphering the small blocks. In step S60 the two-dimensional plaintext is divided and formed into blocks. In step S61 the ciphering attribute of each block is set, for example, by the user. In step S62 each block is divided to generate sub-blocks, in step S63 the ciphering attribute of each sub-block is set, for example, by the user, and in step S64 each sub-block is ciphered. In step S65, the user is allowed to input whether or not to further divide the sub-block into small blocks and cipher the blocks, and the user's instruction is judged. If the process is continued, the process returns to step S62 to regard the sub-block as the original block, generate sub-blocks, and cipher the sub-blocks. If it is judged in step S65 that the process is not continued, in step S66 the original block is ciphered and the processing is ended.

In the above description of the flowcharts, a way of forming blocks or sub-blocks has not particularly been described. This may be designated by the user or by using a specific algorithm. As the specific algorithm, a process of dividing the two dimensional data vertically and horizontally twice may successively be repeated.

Second Embodiment

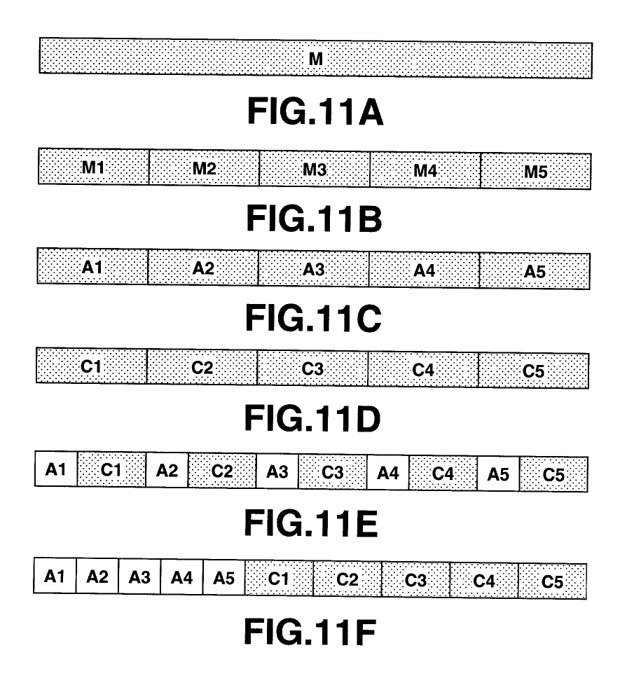

FIGS. 11A to 11F are explanatory views of the concept of a second embodiment according to the present invention.

The first embodiment principally aims at the formation of blocks based on the logical data structure (two dimensional data or the like), but in the present embodiment a physical data constitution is formed into blocks and ciphered.

FIG. 11A schematically shows stream data of the plaintext M. In this manner, the data is one-dimensional data as the stream data on the recording medium. FIG. 11B shows that the plaintext is divided into several blocks. Here, each block length may be arbitrarily set, or may be set to be the same or mutually different. Number “n” attached to M section the block number. FIG. 11C shows the data arrangement with ciphering attribute “An” which defines the ciphering of the plaintext block Mn. Here, “Mn” and “An” are shown to clarify one-to-one correspondence. In actuality, the block and attribute may correctly be associated with each other. For example, even if the order of arrangement of Mn is different from that of “An”, a one-to-one correspondence may be established by a pointer or the like. FIG. 11D shows a block “Cn” of a ciphertext obtained by ciphering the plaintext block Mn with the ciphering attribute An. In this manner, the plaintext stream data is divided into blocks Mn, each block is ciphered based on the attribute An arranged for each block Mn, and a ciphertext stream {Cn} is obtained.

In FIGS. 11A to 1D, the plaintext block Mn and ciphertext block “Cn” are shown as the same length, but these lengths may generally be different from each other.

Since the ciphertext stream data {Cn} and attribute {An} are stored, a deciphering operation may be performed on the stored stream data {Cn} based on the ciphering attribute defined by {An} in order to obtain the plaintext stream data {Mn}.

In FIG. 11A to FIG. 11D, when the plaintext stream data are divided into several blocks, the attribute is determined for each block and the block is ciphered, as in the first embodiment, the ciphering attribute can be finely and effectively set during ciphering of each block. For example, the attribute “this block is not ciphered” can be applied. There can be provided a practical and convenient property in which the ciphered data can be an object of a full-text search without damaging the safety of the ciphered data.

The ciphertext stream data {Cn} and attribute data {An} can be managed separately, but as shown in FIGS. 11E and 11F, {An} and {Cn} may also be managed together as one unit of data. In the example of FIG. 11E, the attribute {An} is added to the top of each ciphered block {Cn}. In this case, the ciphered block {Cn} is physically associated with the attribute {An}. Therefore, the attribute {An}, and ciphered block {Cn} are successively read from the top, and the subsequent ciphered block “Cn” is deciphered in accordance with the attribute {An}, so that the plaintext Mn can be obtained. Moreover, as shown in FIG. 11F, the arrangement of the attribute {An} can also be arranged in the top of the arrangement of the ciphertext block {Cn}. In this case, it is necessary to specify the corresponding ciphered block {Cn} from information such as the order of the arranged attribute {An}. Of course, the pointer indicating an address of the ciphered block {Cn} corresponding to the attribute {An} may also be included.

In the aforementioned embodiment, the plaintext stream data is divided into blocks having arbitrary lengths, and each block is ciphered in accordance with the ciphering attribute defined for each block. As a modification, it is also possible to divide the plaintext stream data into blocks, define the ciphering attribute for the block, further divide the block into micro regions (sub-blocks), set a new attribute to the ciphering of each sub-block, and cipher each sub-block. In the modification, the block obtained by dividing the plaintext stream data is further divided into micro sub-blocks, and the new ciphering attribute is set to each sub-block. Therefore, attribute hierarchy is realized, and the hierarchy of security management is effectively realized based on the hierarchical attribute.

In the modification, the plaintext is formed into blocks, the ciphering attribute is set for each block. Each block is further divided into sub-blocks, and the new ciphering attribute is set for the obtained sub-block. However, it is also possible to regard the “block” obtained by the aforementioned first step procedure as the sub-block, collect several blocks to obtain and constitute a huge block (cluster), and impart the new ciphering attribute to each cluster. In this case, the hierarchical structure of the plaintext block is formally the same as that of the second embodiment, but the hierarchical structure of the ciphering attribute is reversed.

As another modification, the “block” is divided into sub-blocks, and each sub-block is ciphered. Alternatively, after the block is ciphered, and divided into sub-blocks, the sub-block may be ciphered.

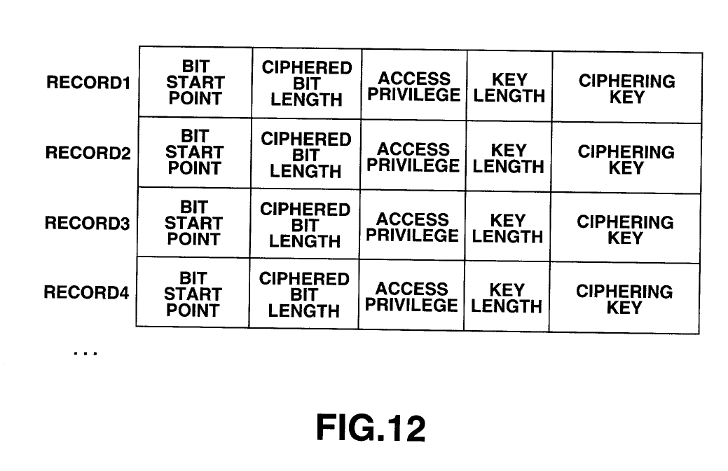

FIG. 12 is a diagram showing an example of the attribute table in the second embodiment.

One record corresponds to each block obtained by dividing the plaintext stream data into blocks. A block start position is shown by a bit unit in each record. Moreover, a block bit length of the corresponding plaintext stream data is stored as an “ciphering bit length” in each record. As in the first embodiment, the “access privilege”, “key length”, and “ciphering key” are registered in the record. When the attribute table is stored as shown in FIG. 1E, the respective records are attached to the respective ciphered blocks at random. These records may differ with all the plaintext blocks, and the same information may sometimes be stored with respect to a plurality of blocks.

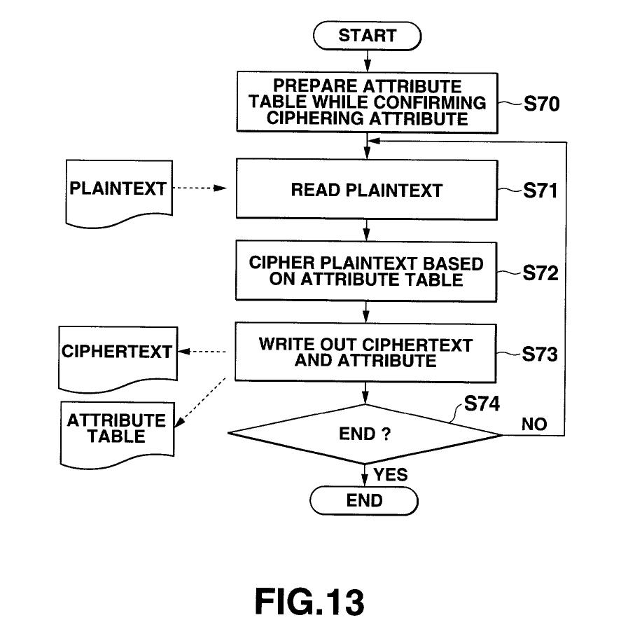

FIG. 13 is a flowchart showing the ciphering process in the second embodiment.

In step S70 the attribute table is prepared while the ciphering attribute is confirmed. The ciphering attribute is inputted, for example, from the user. In step S71 the plaintext is read, and in step S72 the plaintext is ciphered based on the attribute table. In step S73 ciphertext data and attribute data are written out, and it is judged in step S74 whether or not the processing is ended. If there is an instruction for continuation of the process from the user in step S74, the process returns to step S71 and the process is continued. If there is an instruction to end the process from the user in step S74, the process is ended.

For the method of storing the ciphertext data and attribute data, as described above, various methods are possible.

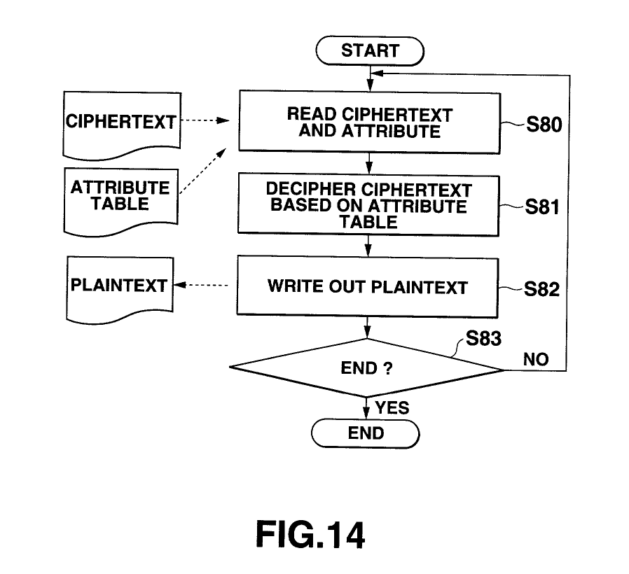

FIG. 14 is a flowchart showing the deciphering process in the second embodiment.

In step S80 ciphertext data and attribute data are read. In step S81 the ciphertext data is deciphered based on the attribute data, and in step S82 the plaintext is written out. In step S83 the user is asked whether or not to end the process. If the process is not ended, the process advances to step S80. If ended, the process is ended as it is.

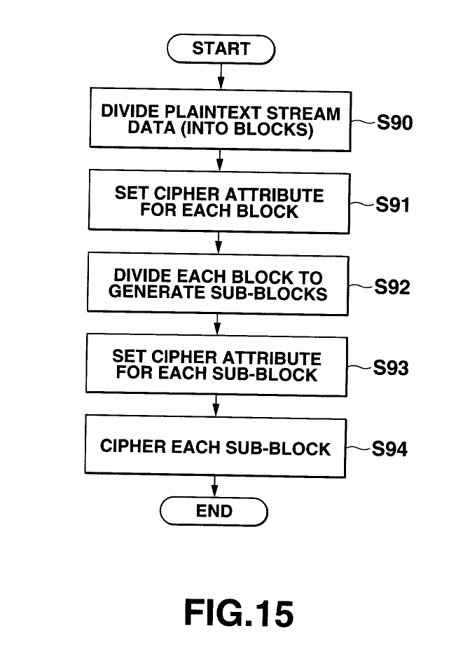

FIG. 15 to FIG. 18 are flowcharts showing ciphering processes for dividing data into sub-blocks and ciphering the sub-blocks in the second embodiment. In FIG. 15, in step S90, the plaintext stream data is divided into blocks. In step S91 the ciphering attribute of each block is set by the user. In step S92 each block is divided to generate sub-blocks, in step S93 the ciphering attribute of each sub-block is set by the user, and in step S94 each sub-block is ciphered and the process is ended. In this case, only the sub-block is ciphered. During the ciphering of the sub-block, however, it is preferable to reflect not only the attribute set to the sub-block but also the attribute set to the original block. For example, the setting of access privilege will be described. For the right to access the sub-block, only the user who satisfies not only the access privilege set to the sub-block attribute but also the access privilege set to the original block is permitted to access the sub-block.

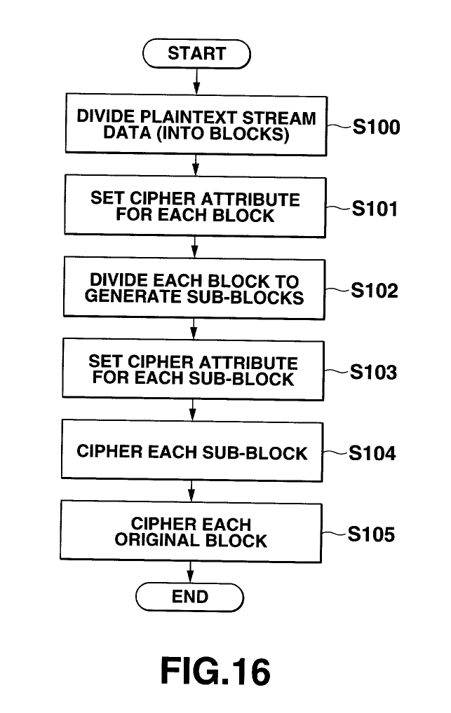

In FIG. 16, in step S100, the plaintext stream data is divided and formed into blocks. In step S101 the ciphering attribute of each block is set by the user. In step S102 each block is divided to generate sub-blocks. In step S103 the ciphering attribute of each sub-block is set by the user, in step S104 each sub-block is ciphered, and in step S105 the original block is ciphered and the process is ended.

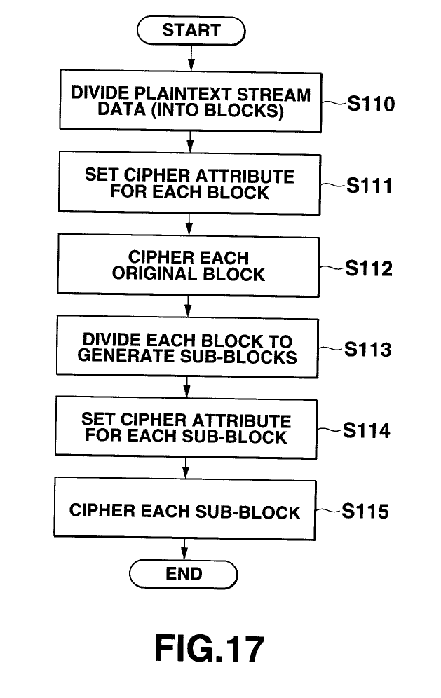

In FIG. 17, in step S110, the plaintext stream data is divided and formed into blocks. In step S111 the ciphering attribute is set to each block by the user, and in step S112 each block is ciphered. In step S113 each ciphered block is divided to generate sub-blocks. In step S114 the ciphering attribute of each sub-block is set by the user, and in step S115 each sub-block is ciphered and the process is ended.

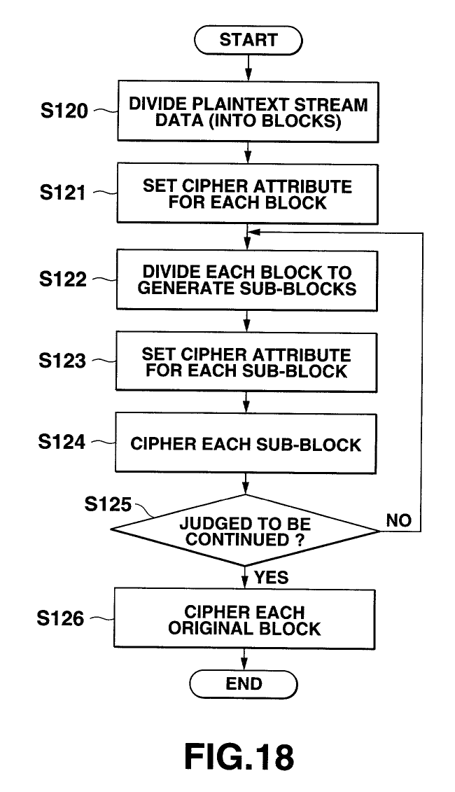

In FIG. 18, in step S120, the plaintext stream data is divided and formed into blocks. In step S121 the ciphering attribute of each block is set by the user. In step S122 each block is divided to generate sub-blocks, in step S123 the ciphering attribute of each sub-block is set by the user, in step S124 each sub-block is ciphered, and it is judged in step S125 whether or not there is an instruction for continuation of the process from the user. If the process is continued, the process returns to step S122 to regard the sub-block as the original block and the process is repeated. If it is judged in step S125 that the process is not continued, the process advances to step S126, the original block is ciphered and the process is ended.

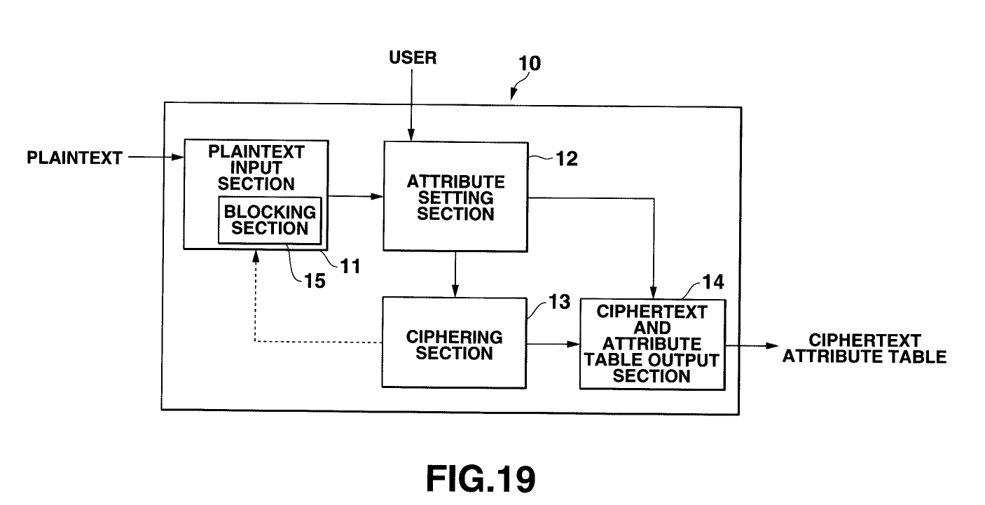

FIG. 19 is a block diagram of a constitution of a ciphering apparatus.

In a ciphering apparatus 10, plaintext is first inputted to a plaintext input section 11. The plaintext input section 11 includes a blocking section 15, and the plaintext is formed into blocks. The blocked plaintext is inputted to an attribute setting section 12, and the user sets the attribute for each block. The blocked plaintext is inputted to a ciphering section 13, and ciphered based on the attribute set to the block. In order to form the sub-block, when the plaintext is inputted to the plaintext input section 11, blocking is performed to obtain the sub-blocks. Alternatively, after the block unit is ciphered by the ciphering section 13, the ciphertext is inputted to the plaintext input section 11, the blocking section 15 is used to generate the sub-blocks, and the attribute is set to the sub-block in the attribute setting section 12. The plaintext ciphered in this manner is sent as ciphertext to a ciphertext and attribute table output section 14. The attribute table is sent to the ciphertext and attribute table output section 14 from the attribute setting section 12, and the ciphertext and attribute table are outputted.

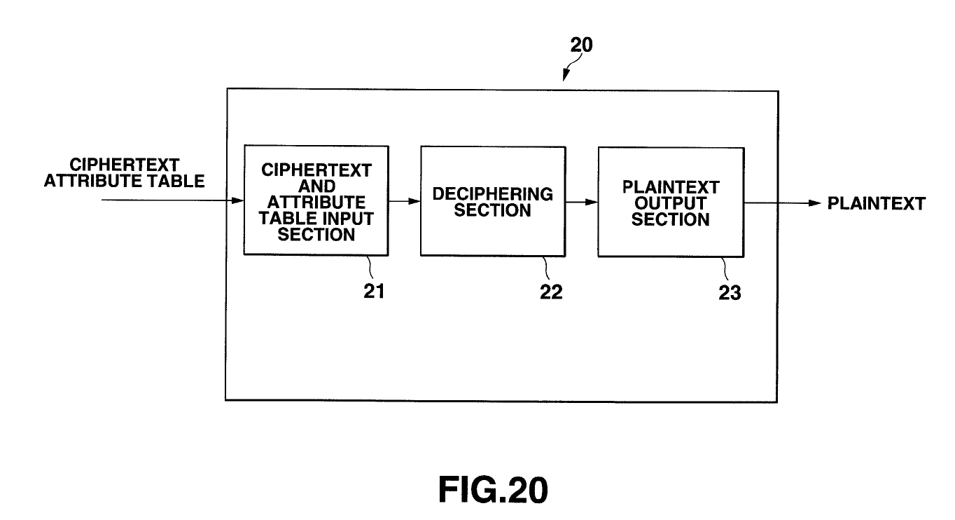

FIG. 20 is a block diagram of a deciphering apparatus.

In a deciphering apparatus 20, the ciphertext and attribute table are inputted to a ciphertext and attribute table input section 21. The data and table are inputted to a deciphering section 22, and the deciphering section 22 refers to the attribute table, deciphers the ciphertext, and reproduces the plaintext. The plaintext is outputted from a plaintext output section 23.

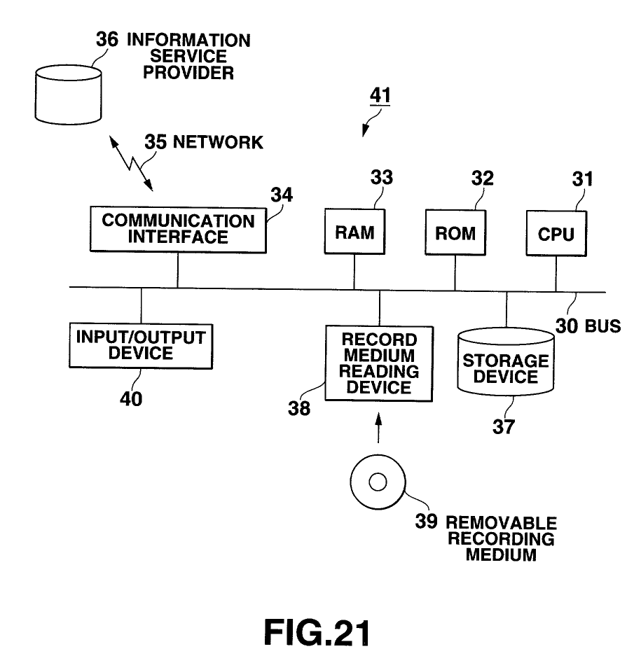

FIG. 21 is a diagram showing a hardware of an information apparatus required for realizing the process of the embodiment by a program.

An information apparatus 41 is formed by connecting a CPU 31, ROM 32, RAM 33, communication interface 34, storage device 37, recording medium reading device 38, and input/output device 40 to a bus 30. Basic programs such as BIOS are stored in the ROM 32. When the CPU 31 reads the program from the ROM 32 during start of the information apparatus 41, the input/output device 40, storage device 37, and the like can be utilized. The program for realizing the embodiment of the present invention is stored in a hard disk or another storage device 37, or removable recording medium 39 such as CD-ROMS, DVDS, MOs, memory cards, and floppy disks. The program is directly read into the RAM 33 from the storage device 37, or read into the RAM 33 from the removable recording medium 39 via the recording medium reading device 38, so that the CPU 31 is brought to an executable state. The plaintext is read into the RAM 33 from the input/output device 40 constituted of a keyboard, mouse, display, scanner, and the like, or read into the RAM 33 from the removable recording medium 39 and storage device 37, so that the CPU 31 can cipher the plaintext. The ciphertext is stored in the removable recording medium 39 or the storage device 37. The attribute table generated in the ciphering processing is also stored in the removable recording medium 39 or the storage device 37.

The information apparatus 41 can also use the communication interface 34, connect to a network 35, and download and execute the program from an information service provider 36. The plaintext is ciphered on an information apparatus 41 side, and the ciphertext and attribute table are transmitted to the information service provider 36 via the network 35, so that ciphertext communication can be performed. Moreover, when the plaintext is received from the information service provider 36 via the network 35, ciphered by the information apparatus 41, and transmitted to the information service provider 36, the information apparatus can perform the ciphering process for the information service provider 36. The information apparatus can also perform deciphering for the information service provider 36. Furthermore, the program can also be executed, while the information service provider 36 is connected to the information apparatus 41 via the network 35, that is, under a network environment.

Additional advantages and modifications will readily occur to those skilled in the art. Therefore, the present invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. A ciphering apparatus comprising:
a blocking section which divides plaintext into blocks;
an attribute setting section which sets a ciphering attribute for use in ciphering each of the blocks;
a ciphering section which ciphers each of the blocks in accordance with a ciphering attribute set for the block to obtain a ciphertext; and
an output section which outputs the ciphertext and the ciphering attribute used for obtaining the ciphertext.

2. The apparatus according to claim 1, wherein the ciphertext and the ciphering attribute outputted by said output section are stored as separate files.

3. The apparatus according to claim 1, wherein the ciphertext and the ciphering attribute outputted by said output section are stored as one file.

4. The apparatus according to claim 1, wherein said ciphering attribute comprises a location information indicating a position of the block, size information indicating a size of the block, user information indicating a user who has a right to access the block, and a ciphering key information.

5. The apparatus according to claim 1, wherein said blocking section comprises a sub-blocking section which divides one block into small sub-blocks;
said attribute setting section comprises a sub-attribute setting section which sets a sub-ciphering attribute for use in ciphering each of the sub-blocks; and
said ciphering section comprises a sub-ciphering section which ciphers each of the sub-blocks in accordance with the sub-ciphering attribute.

6. The apparatus according to claim 5, wherein said ciphering section ciphers the blocks and then ciphers the sub-blocks.

7. The apparatus according to claim 5, wherein said ciphering section ciphers the sub-blocks and then ciphers the blocks.

8. A ciphering method comprising:
dividing plaintext into blocks;
setting a ciphering attribute for use in ciphering each of the blocks;
ciphering each of the blocks in accordance with a ciphering attribute set for the block to obtain a ciphertext; and
outputting the ciphertext and the ciphering attribute used for obtaining the ciphertext.

9. The method according to claim 8, further comprising:
storing the outputted ciphertext and the outputted ciphering attribute as separate files.

10. The method according to claim 8, further comprising:
storing the outputted ciphertext and the outputted ciphering attribute as one file.

11. The method according to claim 8, wherein said ciphering attribute comprises a location information indicating a position of the block, size information indicating a size of the block, user information indicating a user who has a right to access the block, and a ciphering key information.

12. The method according to claim 8, wherein
said blocking comprises dividing one block into small sub-blocks;
said attribute setting comprises setting a sub-ciphering attribute for use in ciphering each of the sub-blocks; and
said ciphering comprises ciphering each of the sub-blocks in accordance with the sub-ciphering attribute.

13. The method according to claim 12, wherein said ciphering comprises ciphering the blocks and then ciphering the sub-blocks.

14. The method according to claim 12, wherein said ciphering comprises ciphering the sub-blocks and then ciphering the blocks.

15. An article of manufacture comprising a computer usable medium having computer readable program code means embodied therein, the computer readable program code means comprising:
computer readable program code means for causing a computer to divide plaintext into blocks;
computer readable program code means for causing a computer to set a ciphering attribute for use in ciphering each of the blocks;
computer readable program code means for causing a computer to cipher each of the blocks in accordance with a ciphering attribute set for the block to obtain a ciphertext; and
computer readable program code means for causing a computer to output the ciphertext and the ciphering attribute used for obtaining the ciphertext.
